(19) United States
(12) Patent Application Publication
(10) Pub. No.: US 2007/0300186 A1
(43) Pub. Date: Dec. 27, 2007

(54) Method for providing menu screen and video apparatus adopting the same

(75) Inventors: Dae-gu Kim, Seoul (KR); Jin-ho Yim, Suwon-si (KR); Sang-hee Lee, Seoul (KR); Dong-heon Lee, Seoul (KR); Won-il Kim, Chungju-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/655,248

(22) Filed: Jan. 19, 2007

(30) Foreign Application Priority Data
Jun. 21, 2006 (KR) 10-2006-0055986

(51) Int. Cl. G06F 3/048

(52) U.S. Cl. 715/828; 715/810

(57) ABSTRACT

A method for providing a menu screen and a video apparatus adopting the method are provided. The method includes generating a menu screen which displays a selected menu item and a selected sub-menu item of a plurality of sub-menu items of the selected menu item on a reference line, indicates a relative position of the selected sub-menu item with reference to the reference line, and combines the menu screen with a video to be displayed.

### CROSS-REFERENCE TO RELATED APPLICATIONS

This application claims priority from Korean Patent Application No. 10-2006-0055986, filed on Jun. 21, 2006 in the Korean Intellectual Property Office, the disclosure of which is incorporated herein by reference.

### BACKGROUND OF THE INVENTION

1. Field of the Invention

Methods and apparatuses consistent with the present invention relate to providing a menu screen, and more particularly, to displaying a menu having a hierarchical structure on a screen to provide the menu to a user.

2. Description of the Related Art

Video apparatuses, such as televisions (TVs) and set-top boxes, have various, complicated functions. Thus, menu screens, which are provided as user interfaces through screens by the video apparatuses, have been diverse and complicated.

Because video apparatuses have many functions, a large number of menu items for explaining the functions are provided on menu screens. Thus, menu screens displaying such menu items in hierarchical structures are widely used to visually arrange the menu items. Meanwhile, it is necessary to show the selected menu items of hierarchical structure effectively so that the users can glance through the menu items.

However, all of the selected menu items may not be displayed on a screen when there are too many menu items selected. Accordingly, there is a need for a method of effectively showing the menu items so that the users can view the all of the menu items.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a method for providing a menu screen which shows the selected menu items of a hierarchical structure in a lateral pattern on a screen so that the users can recognize relative positions of the selected menu items at a glance and recognize that there are other menu items besides the menu selected and displayed on the screen.

According to an aspect of the present invention, there is provided a method for providing a menu screen, including: generating a menu screen that displays a selected menu item and at least one of a plurality of sub-menu items of the selected menu item on a reference line and indicates the relative position of a selected sub-menu item with reference to the reference line; and combining the generated menu screen with a video to be displayed.

According to another aspect of the present invention, there is provided a video apparatus, which includes a combiner that combines a video to be displayed with specified information; and a controller that generates a menu screen that displays a selected menu item and at least one of a plurality of sub-menu items of the selected menu item on a reference line and indicates the relative position of a selected sub-menu item with reference to the reference line, and controls the combiner to combine the generated menu screen with a video to be displayed.

The relative position of the selected sub-menu item may be indicated using the reference line and a position guide which is orthogonal to the reference line.

The position guide may indicate the number of sub-menu items above the selected sub-menu item and the number of sub-menu items below the selected sub-menu item.

The position guide includes marks. The number of marks between the reference line and the top of the position guide indicates the number of sub-menu items above the selected sub-menu item, and the number of marks between the reference line and the bottom of the position guide indicates the number of sub-menu items below the selected sub-menu item.

The reference line may extend horizontally on the menu screen, and the position guide may extend vertically on the menu screen.

The position guide may comprise symbols at a top and a bottom in symmetry to each other.

### BRIEF DESCRIPTION OF THE DRAWINGS

The above and other aspects of the present invention will be more apparent by describing certain exemplary embodiments of the present invention with reference to the accompanying drawings, in which:

FIG. 1 is a block diagram illustrating a video apparatus according to an exemplary embodiment of the present invention;

FIG. 2 is a flowchart illustrating a method for providing a menu screen according to an exemplary embodiment of the present invention;

FIGS. 3 and 4 are views illustrating a menu screen generated in operation S250 of the method of FIG. 2, according to exemplary embodiments of the present invention;

FIGS. 5 and 6 are views illustrating the menu screen generated in operation S250 of the method of FIG. 2, according to exemplary embodiments of the present invention;

FIG. 7 is a block diagram of a video apparatus according to another exemplary embodiment of the present invention; and

FIG. 8 is a flowchart illustrating a method of providing menu screen according to another exemplary embodiment of the present invention.

### DETAILED DESCRIPTION OF THE EXEMPLARY EMBODIMENTS OF THE INVENTION

Exemplary embodiments of the present invention will be described in detail with reference to the annexed drawings. In the drawings, the same elements are denoted by the same reference numerals throughout the drawings. In the following description, detailed descriptions of known functions and configurations incorporated herein have been omitted for conciseness and clarity.

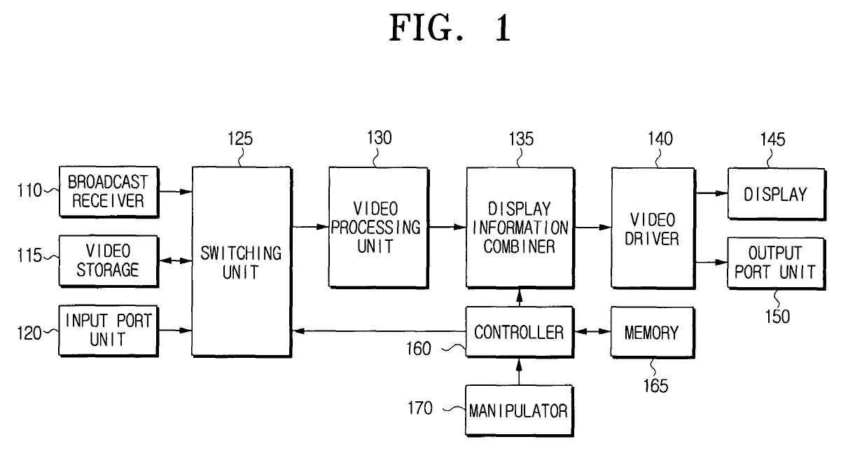

FIG. 1 is a block diagram illustrating a video apparatus according to an exemplary embodiment of the present invention. The video apparatus according to an exemplary embodiment displays a menu of a hierarchical structure on a screen as an interface between a user and the video apparatus. The video apparatus displays selected menu items laterally on the menu screen. Additionally, the menu items are laterally displayed on the menu screen such that the user can readily recognize relative positions of the menu items.

As shown in FIG. 1, the video apparatus includes a broadcast receiver 110, a video storage 115, an input port unit 120, a switching unit 125, a video processing unit 130, a display information combiner 135, a video driver 140, a display 145, an output port unit 150, a controller 160, a memory 165, and a manipulator 170.

The broadcast receiver 110 tunes and demodulates a television (TV) broadcast. The video storage 115 stores a video or reads a stored video. The input port unit 120 communicates with an external device to transmit data to and/or receive data from the external device.

The switching unit 125 performs a switching operation to transmit one of a plurality of videos output from the broadcast receiver 110, the video storage 115, and the input port unit 120 to the video processing unit 130. The switching operation of the switching unit 125 is controlled by the controller 160 that will be described later.

The video processing unit 130 processes the video received through the switching unit 125 to display the video.

The display information combiner 135 combines the video output from the video processing unit 130 with display information such as characters, symbols, figures, graphics, etc. The display information combiner 135 may combine the display information using an on-screen display (OSD) method. The combination processing operation of the display information combiner 135 is controlled by the controller 160.

The video driver 140 displays the video combined with the display information on the display 145 or transmits the video to an external device through the output port unit 150, wherein the video is output from the display information combiner 135.

The controller 160 controls the video apparatus using a program and data stored in the memory 165 according to a manipulation command of a user input through the manipulator 170.

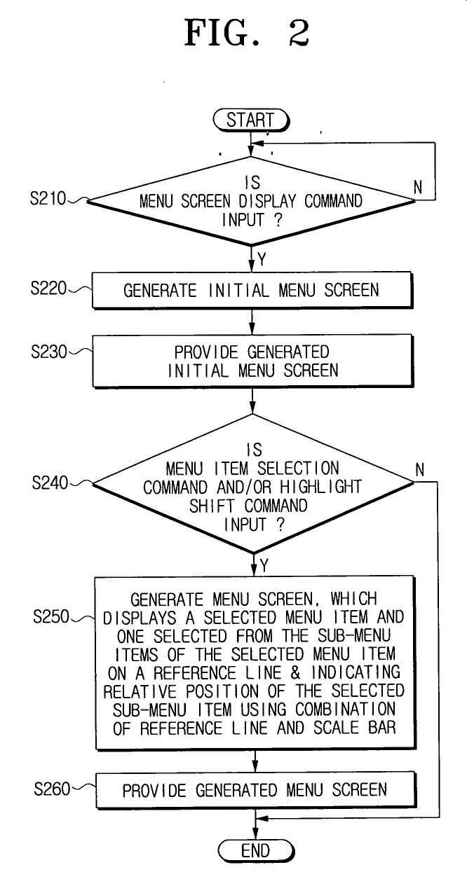

In particular, the controller 160 controls the video apparatus to display a menu screen on a screen so that the user may interface with the video apparatus. A process of providing the menu screen in the controller 160 will now be described with reference to FIG. 2.

FIG. 2 is a flowchart illustrating a method for providing a menu screen according to an exemplary embodiment of the present invention. Referring to FIG. 2, in operation S210, a determination is made as to whether a menu screen display command has been input from a user through the manipulator 170. If it is determined in operation S210 that the menu screen display command has been input, the controller 160 generates an initial menu screen in operation S220. In operation S230, the controller 160 controls the display information combiner 135 to provide the initial menu screen on a screen. Thus, a video combined with the initial menu screen is displayed on the display 145.

Menu items are displayed on the initial menu screen, and a highlight (a cursor) is positioned in one of the displayed menu items.

In operation S240, it is determined whether a menu screen selection command and/or a highlight shift command have been input from the user through the manipulator 170. If it is determined in operation S240 that the menu screen selection command and/or the highlight shift command have been input, the controller 160 generates a menu screen, which laterally displays the selected menu items and indicates the relative position of the lowest menu item using a vertical scale bar according to the menu screen selection command and/or the highlight shift command in operation S250. In operation S260, the controller 160 controls the display information combiner 135 to provide the menu screen generated in operation S250 on the screen. Thus, a video combined with the menu screen generated in operation S250 is displayed on the display 145.

The menu screen generated in operation S250 will now be described in detail.

A selected menu item and one that is selected from the sub-menu items of the selected menu item are shown on the same line on the menu screen generated in operation S250.

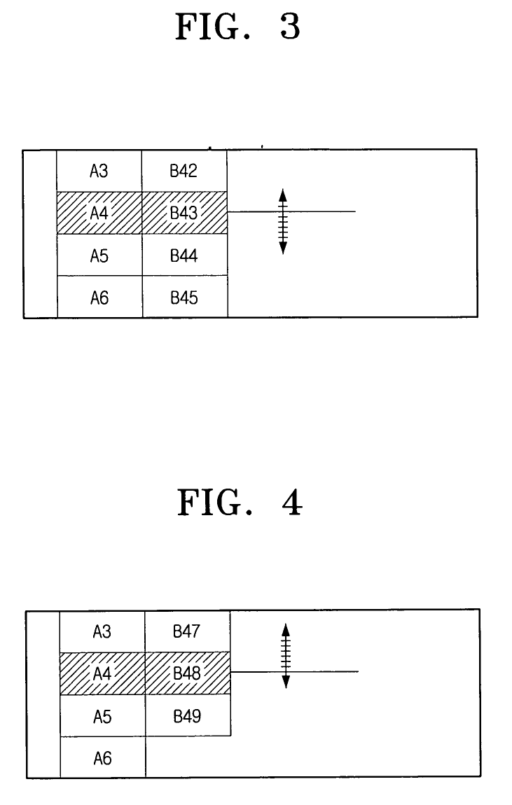

FIG. 3 illustrates the menu screen generated in operation S250 according to an exemplary embodiment of the present invention. Referring to FIG. 3, the menu item A4 and one sub-menu item B43 that is selected from plurality of sub-menu items of the selected menu item A4 are displayed on the same line.

Also, the relative position of the selected sub-menu item is displayed on the menu screen generated in operation S250. The relative position of the selected sub-menu item may be displayed using a vertical scale bar which moves up and down the menu items.

The scale bar is displayed on the right side of the sub-menu items B42 through B45. Referring to FIG. 3, a reference line extends from the selected menu item and its selected sub-menu item, and the vertical menu bar as the position guide is shown in an orthogonal relation to the reference line.

The marks (including the arrow marks) on the scale bar indicate: i) the number of sub-menu items above the currently selected sub-menu item; and ii) the number of sub-menu items below the currently selected sub-menu item.

In more detail, the number of marks above the reference line indicates the number of sub-menu items above the currently selected sub-menu item, and the number of marks below the reference line indicates the number of sub-menu items before the currently selected sub-menu item.

Referring to FIG. 3, there are two marks (including one arrow mark) above the reference line. Thus, the user can know that there are two sub-menus B41 and B42 above the currently selected sub-menu item B43. Likewise, because there are six marks (including one arrow mark) above the reference line, the user recognizes that there are six sub-menu items B44, B45, B46, B47, B48, and B49 below the currently selected sub-menu item B43.

Referring to FIG. 4, because the number of marks above the reference line is “7,” the user recognizes that there are seven sub-menu items B41, B42, B43, B44, B45, B46, and B47 above the currently selected sub-menu item B48. Also, because there is only one mark, that is the arrow mark, below the reference line, the user recognizes that there is one sub-menu item B49 below the currently selected sub-menu item B48.

The arrow marks “ [symbol] [symbol] ” are on the top and bottom of the scale bar in symmetry to each other as shown in FIGS. 3 and 4 to assist the user in perceiving the menu items.

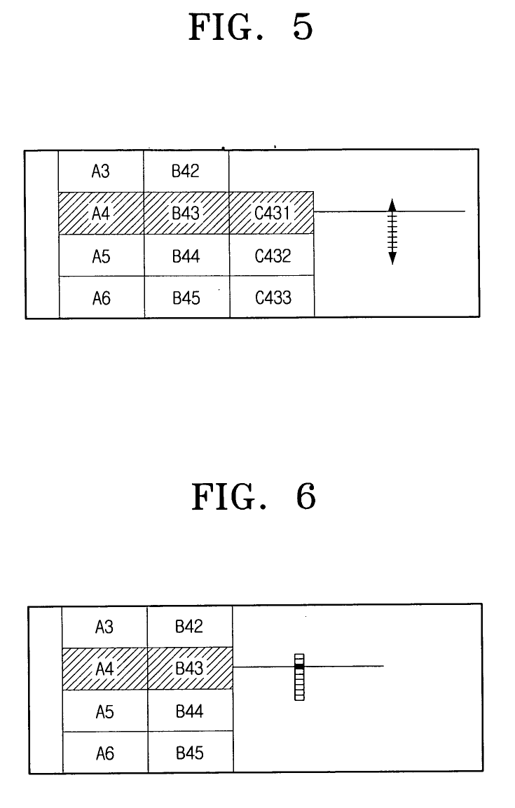

FIGS. 5 and 6 illustrate the menu screen generated in operation S250, according to another exemplary embodiment of the present invention. Exemplary embodiments of the present invention may be applied to a menu screen having a three or more hierarchical structure shown in FIG. 5 as well as to the menu screen having a two hierarchical structure shown in FIGS. 3 and 4. Additionally, the position guide may have various forms in addition to the scale bar shown in FIGS. 3 through 5, such as the one shown in FIG. 6.

Although not shown in FIGS. 5 and 6, the position guide displayed on the menu screen may not have the marks.

In addition, although the position guide of FIGS. 3 through 6 indicate the sub-menu item, in an alternative example, the position guide may also indicate the upper menu items. In this case, the position guide of the upper menu items may be displayed between upper menu items and sub-menu items.

Since the video apparatus illustrated in FIG. 1 is only one of various exemplary embodiments, it is not strictly necessary that a video apparatus includes all of blocks illustrated in FIG. 1. In other words, unnecessary blocks may be omitted. For example, the display 145 may be omitted if the video apparatus is a set-top box.

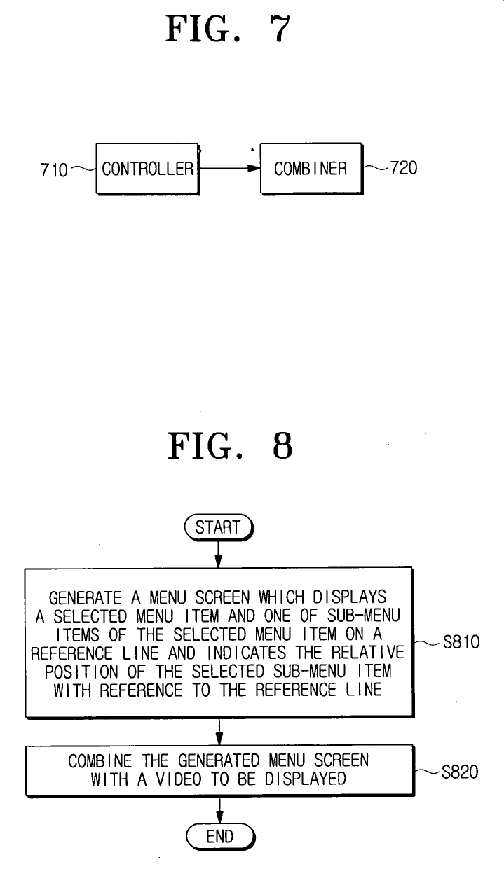

Another exemplary embodiment of the present invention will be explained below with reference to FIGS. 7 and 8.

With reference to FIG. 7, a video apparatus according to another exemplary embodiment of the present invention includes a controller 710 and a combiner 720. The combiner combines a video to be displayed with specified information. The controller 710 generates a menu screen which displays a selected menu item and one of a plurality of sub-menu items of the selected menu item on a reference line and indicates the relative position of a selected sub-menu item with reference to the reference line, and controls the combiner 720 to combine the generated menu screen with a video to be displayed.

With reference to FIG. 8, the controller 710 generates a menu screen which displays a selected menu item and one of a plurality of sub-menu items of the selected menu item on a reference line and indicates the relative position of a selected sub-menu item with reference to the reference line (S810), and controls the combiner 720 to combine the generated menu screen with a video to be displayed (S820).

As described above, according to the exemplary embodiments of the present invention, a user can be provided with a menu screen which displays selected menu items of the menu of a hierarchical structure laterally on the same line, such that the user can recognize the relative positions of the selected menu items at a glance. Additionally, the user can know that there are other menu items even when some menu items are not displayed on the screen.

While the invention has been shown and described with reference to certain embodiments thereof, it will be understood by those skilled in the art that various changes in form and details may be made therein without departing from the spirit and scope of the invention as defined by the appended claims.

What is claimed is:

1. A method for providing a menu screen, the method comprising:
generating a menu screen which displays a selected menu item and a selected sub-menu item of a plurality of sub-menu items of the selected menu item on a reference line and indicates a relative position of the selected sub-menu item with reference to the reference line; and
combining the menu screen with a video to be displayed.

2. The method as claimed in claim 1, wherein the relative position of the selected sub-menu item is indicated using the reference line and a position guide which is orthogonal to the reference line.

3. The method as claimed in claim 2, wherein the position guide indicates a number of the plurality of sub-menu items above the selected sub-menu item and a number of the plurality of sub-menu items below the selected sub-menu item.

4. The method as claimed in claim 2, wherein the position guide comprises a plurality of marks and a number of the plurality of marks above the reference line indicates a number of the plurality of sub-menu items above the selected sub-menu item, and a number of the plurality of marks below the reference line indicates a number of the plurality of sub-menu items below the selected sub-menu item.

5. The method as claimed in claim 2, wherein the reference line extends horizontally on the menu screen, and the position guide extends vertically on the menu screen.

6. The method as claimed in claim 2, wherein the position guide comprises symbols at a top of the position guide and a bottom of the position guide which are symmetrical to each other.

7. The method as claimed in claim 1, wherein the reference line extends horizontally on the menu screen.

8. A video apparatus comprising:
a combiner that combines a video to be displayed with specified information; and
a controller that generates a menu screen which displays a selected menu item and a selected sub-menu item of a plurality of sub-menu items of the selected menu item on a reference line and indicates a relative position of the selected sub-menu item with reference to the reference line, and controls the combiner to combine the menu screen with a video to be displayed.

9. The video apparatus as claimed in claim 8, wherein the relative position of the selected sub-menu item is indicated using the reference line and a position guide which is orthogonal to the reference line.

10. The video apparatus as claimed in claim 9, wherein the position guide indicates a number of the plurality of sub-menu items above the selected sub-menu item and a number of the plurality of sub-menu items below the selected sub-menu item.

11. The video apparatus as claimed in claim 9, wherein the position guide comprises a plurality of marks and a number of the plurality of marks above the reference line indicates a number of the plurality of sub-menu items above the selected sub-menu item, and a number of the plurality of marks below the reference line indicates a number of the plurality of sub-menu items below the selected sub-menu item.

12. The video apparatus as claimed in claim 9, wherein the reference line extends horizontally on the menu screen, and the position guide extends vertically on the menu screen.

13. The video apparatus as claimed in claim 9, wherein the position guide comprises symbols at a top of the position guide and a bottom of the position guide which are symmetrical to each other.

14. The video apparatus as claimed in claim 8, wherein the reference line extends horizontally on the menu screen.
